(19) United States
(12) Patent Application Publication
(10) Pub. No.: US 2018/0161996 A1
(43) Pub. Date: Jun. 14, 2018

(54) BEARD TRIMMER WITH ONE OR MORE ROTARY HEADS SURROUNDED BY COMBS HAVING A PARTICULAR SHAPE AND PROVIDED WITH A COMB PROTECTION POSITION

(71) Applicant: BaByliss Faco sprl, Wandre (BE)

(72) Inventors: Pierre JULEMONT, Soumagne (BE); Olivier SMAL, Magnee (BE)

(73) Assignee: BaByliss Faco sprl, Wandre (BE)

(21) Appl. No.: 15/579,683

(22) PCT Filed: Apr. 22, 2016
(86) PCT No.: PCT/EP2016/059027

§ 371 Date: Dec. 5, 2017

(30) Foreign Application Priority Data
Jun. 8, 2015 (EP) 15170953.2

(51) Int. Cl. B26B 19/18; B26B 19/20; B26B 19/38

(52) U.S. Cl. CPC B26B 19/18; B26B 19/20; B26B 19/3886; B26B 19/3853; B26B 19/3846

(57) ABSTRACT

The present invention relates to a beard trimmer having a handle and a cover, as well as a cutting system with one or more vertical axis rotary cutting heads, said rotary cutting heads having a moving blade and a fixed blade, each head being surrounded by a crown-shaped comb, said comb being adjustable in height in order to adjust, in use, the distance between said blades and the skin, and thereby to adapt the cutting of the beard to the desired length, characterized in that the cover is movably mounted between a closed position and an open position on said handle such that the cover can be moved from an open position to a protection position where it is flush with the comb tines in order to store the device.

### FIELD OF THE INVENTION

The present invention relates to a beard trimmer comprising one or several rotary cutting heads with a vertical axis. The cutting mechanism of these rotary heads is equipped with a moving blade and a fixed blade. Each cutting head is surrounded by crown-shaped combs, the height of which is adjustable and the teeth of which have a particular geometry. In use, adjusting the height of the combs makes it possible to adjust the distance between the cutting mechanism and the skin, and thus to adjust the cutting length of the beard.

The teeth of the comb may have a length of up to 20 mm and become thinner at the end, which may cause them to break during careless manipulation. To avoid this problem, the trimmer according to the invention comprises a removably mounted cover that makes it possible to reach a protection position for the combs, where the cover is practically brought flush with the teeth of the comb in order to store the device.

### BACKGROUND OF THE INVENTION

The beard trimmers of the state of the art have linear moving and fixed blades, the operation of which is based on a to-and-fro movement of the moving blade relative to the fixed blade. This type of trimmer is generally equipped with a comb that allows it to adjust the cutting length of the beard. Such beard trimmers are for example disclosed in US D 698,084, U.S. Pat. No. 6,978,547, US D 486,267, EP 2 766 153 A1, US D 363,809, US 2013/0042487, U.S. Pat. No. 7,076,878, US D 521,683, etc.

Of course, razors with multiple rotary heads exist that make it possible to achieve a very close shave, but they cannot be used to trim a beard. Razors do not have combs to adjust the distance between the cutting mechanism and the skin. To the best of our knowledge, no beard trimmer with rotary heads having a vertical axis exists in the state of the art.

The trimmers of the state of the art have a straight cutting line at the intersection of the moving teeth and fixed teeth. They have the drawback of trimming the hairs differently depending on the trimming direction, since the beard hairs are most often inclined in a direction, given that they almost never grow perpendicular to the skin. The result of trimming with these trimmers is thus very different depending on the movement direction over the beard to be trimmed.

Trimmers with cutting heads having a vertical axis comprising a protection position for the combs are not known in the state of the art.

### AIMS OF THE INVENTION

The present invention aims to provide a beard trimmer with one or several rotary heads surrounded by combs with an adjustable length making it possible to adjust the cutting height of the beard. The trimmer comprises a cover that is movably mounted with a mechanism that makes it possible to reach a protection position for the combs in which the cover is brought, by translation, approximately flush with the teeth of the comb in order to store the device.

The present invention also discloses a trimmer with combs comprising teeth with a particular geometry favoring the penetration of the hairs in the cutting system.

### SUMMARY OF THE INVENTION

The present invention discloses a beard trimmer comprising a handle and a cover, as well as a cutting system with one or several vertical axis rotary cutting heads, said rotary cutting heads comprising a moving blade and a fixed blade, each head being surrounded by a crown-shaped comb, said comb being height adjustable and allowing to adjust, in use, the distance between said blades and the skin, and thereby to adapt the cutting of the beard hairs to the desired length, characterized in that said cover is movably mounted between a closed position and an open position on said handle such that the cover can be moved from an open position into a protection position where it is flush with the teeth of the comb in order to store the device.

The preferred embodiments of the invention comprise at least one, or any appropriate combination, of the following features:
the protection position for the combs is reached by actuating a means for moving the cover away from the handle;
the cover is translated along the direction of a shaft to reach the protection position for the combs;
the means for moving the cover away releases the latter from its anchoring so as to cause the translational movement by a spring located around the shaft to reach the protection position for the combs;
the movement of the cover away from the handle is motorized;
said trimmer comprises two or three rotary heads;
the ratio between the spacing of the teeth L1 of the comb and their thickness R1-R2, that is to say the ratio L1/R1-R2, is situated between 1 and 2, preferably between 1 and 1.8, and particularly preferably between 1.1 and 1.6 to ensure adequate penetration of the hairs in the fixed blade of the cutting system;
the ratio between the height H of the teeth and the surface area of their section at the base of the comb is situated between 2 and 4, preferably between 2.3 and 3.5, and particularly preferably between 2.5 and 3 mm⁻¹;
the axial angle “A” varies between 7 and 11°, preferably between 8 and 10°, and particularly preferably from 8.5 to 9.5°;
the radial angle “B” generally varies from 8 to 22° , preferably between 9 and 20°, and particularly preferably from 10 to 19°.

### BRIEF DESCRIPTION OF THE FIGURES

FIG. 1 shows a beard trimmer according to the invention comprising three vertical axis rotary heads. The crown-shaped comb around the rotary heads is shown with three different adjustment heights. These three adjustments for example make it possible to obtain hair lengths of 2, 6 and 10 mm.

FIG. 2 shows the trimmer according to the invention with one or two vertical axis cutting heads, respectively.

FIG. 3 shows a detailed view of the operating mechanism of the trimmer according to the invention with various beard cutting lengths.

FIG. 4 shows the trimmer in its protection position for the combs with the cover brought approximately flush with the end of the teeth of the combs. The movement of the cover creates a slit between the handle and the cover.

FIG. 5 shows a sectional view of the trimmer according to the invention with the mobility mechanism making it possible to reach the position of the cover protecting the combs.

FIG. 6 shows the important parameters defining the geometry and spacing of the teeth of the combs around the cutting heads.

FIG. 7 shows three dimensioning examples of the combs.

FIG. 8 shows different possible shapes for the base of the teeth of the combs of the trimmer according to the invention.

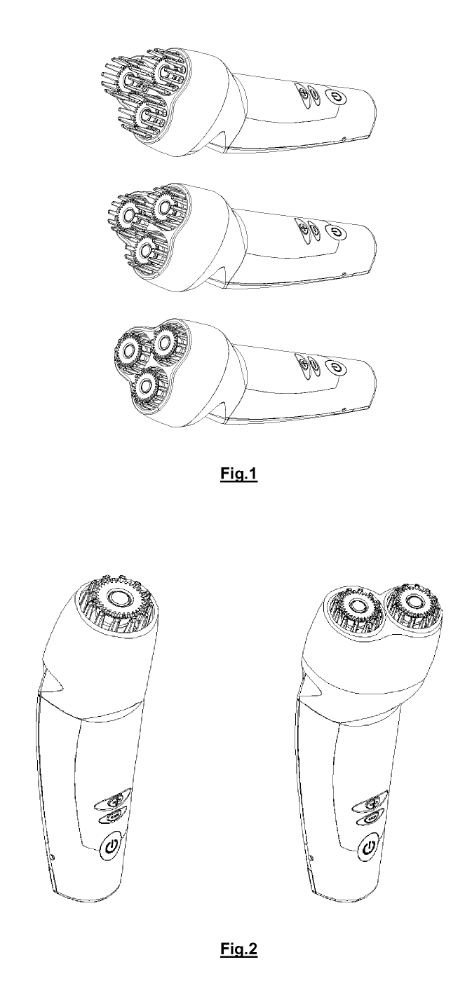

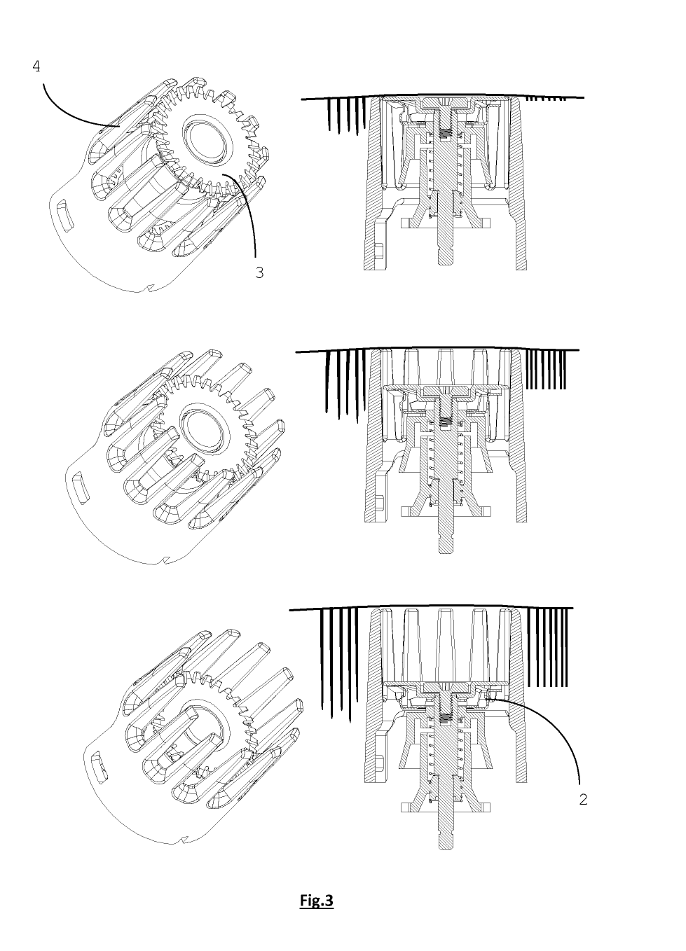

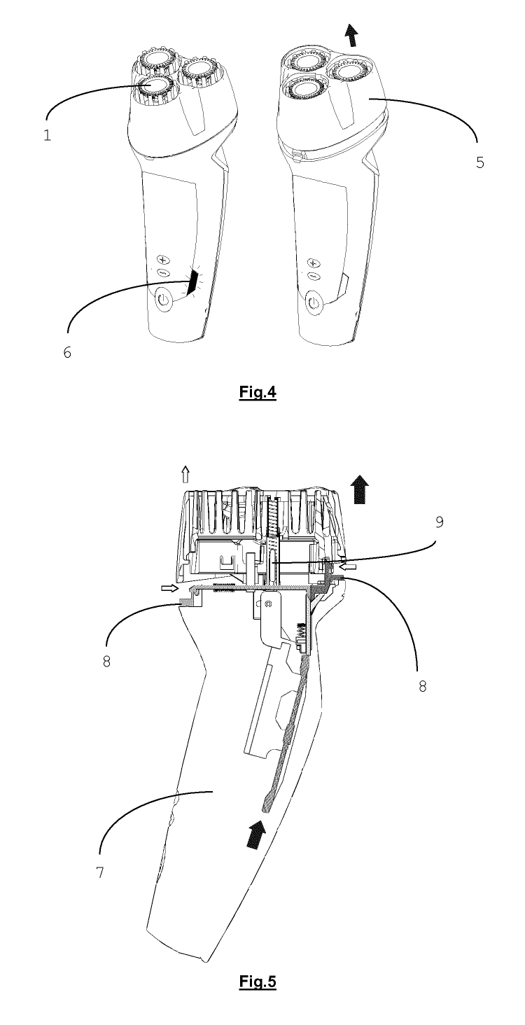

### LIST OF REFERENCE SYMBOLS

1. Rotary cutting head with a vertical axis

2. Moving blade

3. Fixed blade

4. Crown-shaped comb surrounding the cutting head

5. Cover

6. Push button causing the cover to start moving toward the protection position for the comb

7. Handle

8. Anchoring of the cover

9. Shaft

### DETAILED DESCRIPTION OF THE INVENTION

Unlike the beard trimmers of the state of the art, the trimmer according to the present invention has one or several vertical axis rotary heads 1, surrounded by crown-shaped combs 4, the height of which can be adjusted to within half a millimeter. This adjustment can be manual or motorized (not shown). This trimmer allows a movement in arcs of circle over the beard, just like a rotary head razor. This type of movement has the advantage of beginning to trim the hairs from all sides, irrespective of the incline thereof relative to the skin, which results in uniform trimming of the beard.

The movement of the combs 4 raises the hairs, which ultimately penetrate from the outside toward the inside via the space left between the teeth toward the trimming zone. The particular shape of the teeth of the comb 4, which become gradually finer toward the tip, allows easy penetration of the beard hairs toward the trimming element made up of a fixed blade 3 and a moving blade 2.

The fixed blade 3 comprises radial notches, which also favors the penetration of the hairs in the cutting mechanism.

The height of the telescoping combs 4 can be adjusted approximately between 0 and 15 mm, preferably between 0 and 12 mm, and particularly preferably between 0 and 10 mm. Given the length of the combs, they are not completely retractable in the cover 5 to potentially occupy less space when storing the trimmer. The trimmer therefore requires a protection mechanism for the teeth of the combs. This position is shown in FIG. 4. It is reached by releasing the cover from its anchoring 8 by an appropriate means (push button, for example). Once the cover has been released, it moves away from the handle 7 and is translated toward the tip of the teeth of the combs so as to bring the outer surface of the cover 5 approximately flush with the teeth of the combs.

To improve the penetration of the beard hairs through the teeth of the combs, the latter have a particular shape and spacing.

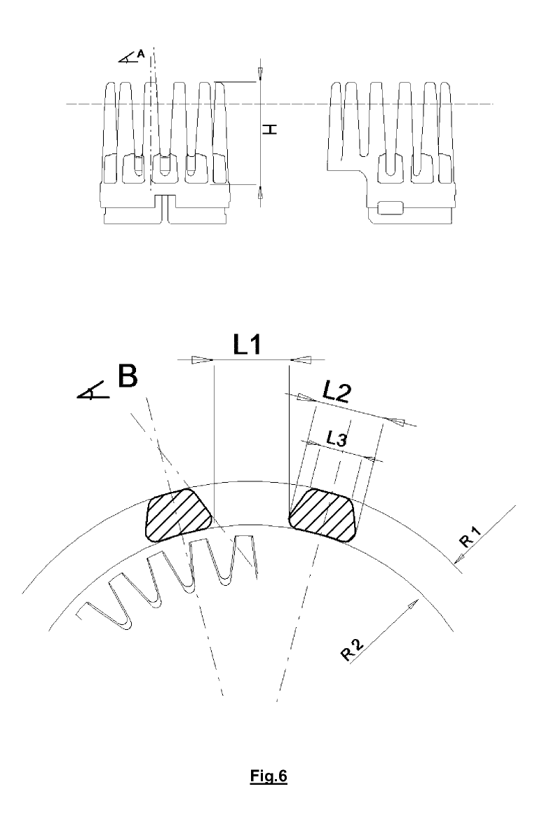

The important parameters of the geometry and arrangement of the teeth of the combs are shown in FIG. 6.
“A” represents the axial angle of the comb, while “B” represents the radial angle;
L1 represents the distance between the teeth, L2 represents the large width of the tooth at the base, and L3 the small width of the tooth at the base;
R1 and R2 respectively represent the outer radius and the inner radius of the crown of teeth;
H represents the height of the tooth.

There is a relationship between these parameters, and a smaller thickness of the teeth must be compensated by a greater width to ensure sufficient rigidity, which reduces the space between the teeth and may prove unfavorable for the penetration of the hairs through the teeth toward the cutting system.

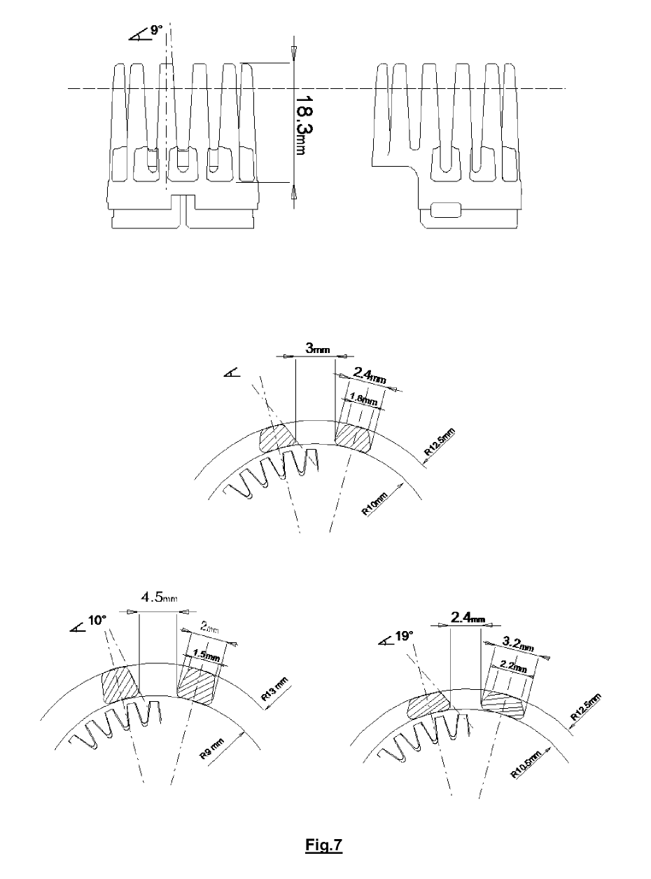

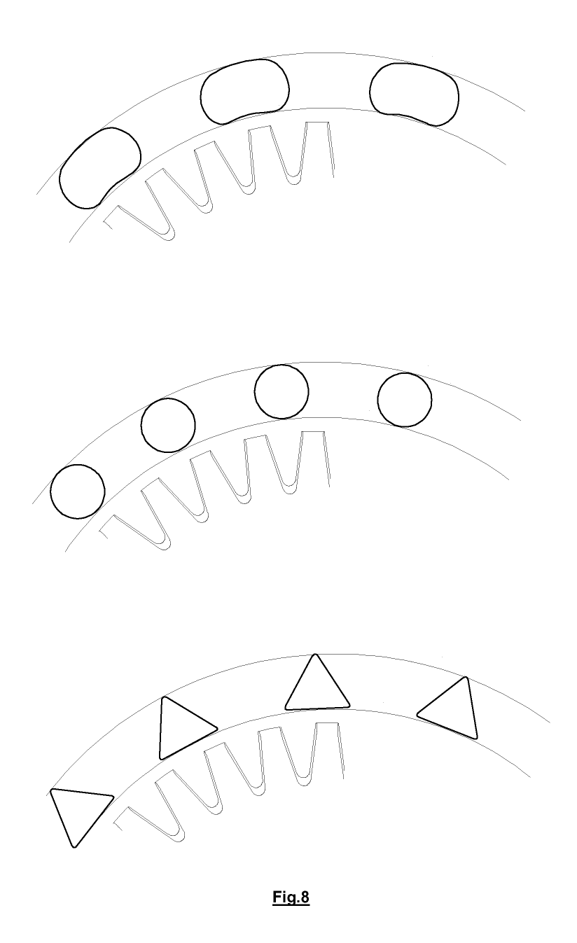

FIG. 7 shows three dimensioning examples of the combs. The examples are only intended to illustrate the invention, without limiting it. In these examples, one can see that the thickness of the teeth (E=R1-R2) varies from 2 to 4 mm. The space between the teeth varies from 2.4 to 4.5 mm. The angle “A” is 9°, and the angle “B” varies from 10 to 19°.

Experiments have shown that the ratio between the spacing of the teeth L1 and their thickness: L1/R1-R2 should be situated between 1 and 2, preferably between 1 and 1.8, and particularly preferably between 1.1 and 1.6 to ensure adequate penetration of the hairs in the fixed blade of the cutting system.

The angles “A” and “B” also play an important role, since they determine the penetration angle of the beard hairs toward the fixed blade. The variation of these angles must of course be compatible with the other dimensions of the tooth. The larger “A” is, the pointier the teeth are, and in principle more fragile if L2 and L3 are not too large. The axial angle “A” preferably varies between 7 and 11°, preferably between 8 and 10°, and particularly preferably from 8.5 to 9.5°. The angle “B” generally varies from 8 to 22°, preferably between 9 and 20°, and particularly preferably from 10 to 19°. The angle is of course smaller for high thicknesses (R1-R2) than for low thicknesses.

Furthermore, for rigidity and mechanical strength reasons, the ratio between the height H of the teeth and their section surface area at the base of the comb (that is to say H/Section) should be situated between 2 and 4, preferably between 2.3 and 3.5, and particularly preferably between 2.5 and 3 mm⁻¹. The section of the base of the tooth is calculated by the formula (R1-R2).(L2-L3/2), multiplying the thickness of the tooth by the average of its base.

The section of the base of the tooth can also be measured if it does not correspond to a precise geometric shape.

1. A beard trimmer comprising a handle and a cover, as well as a cutting system with one or several vertical axis rotary cutting heads, said rotary cutting heads comprising a moving blade and a fixed blade, each head being surrounded by a crown-shaped comb with teeth, said comb being height adjustable and allowing to adjust, in use, the distance between said blades and the skin, and thereby to adapt the cutting of the beard hairs to the desired length, characterized in that said cover is movably mounted between a closed position and an open position on said handle such that the cover can be moved from an open position into a protection position where it is flush with the teeth of the comb in order to store the device.

2. The beard trimmer according to claim 1, wherein the protection position for the combs is reached by actuating a means for moving the cover away from the handle.

3. The beard trimmer according to claim 1, wherein the cover is translated along the direction of a shaft to reach the protection position for the combs.

4. The beard trimmer according to claim 1, wherein the means for moving the cover away releases the latter from its anchoring so as to cause the translational movement by a spring located around the shaft to reach the protection position for the combs.

5. The beard trimmer according to claim 1, wherein the movement of the cover away from the handle is motorized.

6. The beard trimmer according to claim 1, wherein said trimmer comprises two or three rotary heads.

7. The beard trimmer according to claim 1, wherein the ratio between the spacing of the teeth L1 of the comb and their thickness R1-R2, that is to say the ratio L1/R1-R2, is situated between 1 and 2, preferably between 1 and 1.8, and particularly preferably between 1.1 and 1.6 to ensure adequate penetration of the hairs in the fixed blade of the cutting system.

8. The beard trimmer according to claim 1, wherein the ratio between the height H of the teeth and the surface area of their section at the base of the comb is situated between 2 and 4, preferably between 2.3 and 3.5, and particularly preferably between 2.5 and 3 mm⁻¹.

9. The beard trimmer according to claim 1, wherein the axial angle “A” varies between 7 and 11°, preferably between 8 and 10°, and particularly preferably from 8.5 to 9.5°.

10. The beard trimmer according to claim 1, wherein the radial angle “B” generally varies from 8 to 22°, preferably between 9 and 20°, and particularly preferably from 10 to 19°.
